(19) United States
(12) Patent Application Publication
(10) Pub. No.: US 2015/0377708 A1
(43) Pub. Date: Dec. 31, 2015

(54) OPTICAL SYSTEM AND ARRAY SUBSTRATE DETECTING DEVICE

(71) Applicants: BOE TECHNOLOGY GROUP CO., LTD., Beijing (CN); BEIJING BOE OPTOELECTRONICS TECHNOLOGY CO., LTD., Beijing (CN)

(72) Inventors: Chong LIU, Beijing (CN); Haisheng ZHAO, Beijing (CN)

(21) Appl. No.: 14/495,465

(22) Filed: Sep. 24, 2014

(30) Foreign Application Priority Data
Jun. 30, 2014 (CN) 201410306754.X

(51) Int. Cl. G01J 4/04; G01N 21/21; G01J 1/44; G02B 5/30; G02B 27/28

(52) U.S. Cl. CPC G01J 4/04; G02B 5/3016; G02B 27/283; G01J 1/44; G01N 21/21; G01N 2201/12; G01N 2201/0683

(57) ABSTRACT

A optical system comprises: a light source; a first polarizer, configured to receive light emitted by the light source and convert it into first linearly polarized light; an optical prism group, configured to receive the first linearly polarized light and reflect it to a liquid crystal detecting head; the liquid crystal detecting head, configured to convert the first linearly polarized light into second linearly polarized light by using optical rotation characteristic of liquid crystal molecules, and emit the second linearly polarized light; a second polarizer, configured to receive the second linearly polarized light reflected by the liquid crystal detecting head and transmitted by the optical prism group, and convert the second linearly polarized light into third linearly polarized light; a light intensity detector, configured to receive the third linearly polarized light and calculate a light intensity thereof; wherein, the polarization directions of the first and second polarizers are opposite.

### CROSS-REFERENCE TO RELATED APPLICATION

This application claims priority to Chinese Patent Application No. 201410306754.X filed on Jun. 30, 2014, the disclosures of which are incorporated in their entirety by reference herein.

### TECHNICAL FIELD

The present disclosure relates to the field of display technology, in particular to an optical system and an array substrate detecting device.

### BACKGROUND

Generally, there are three stages in a current process for manufacturing a thin film transistor-liquid crystal display (TFT-LCD): 1, an array process, wherein several independent TFT pixel array circuits are formed on a large glass substrate, each of pixel array areas corresponds to an LCD screen; 2, a cell forming process, wherein liquid crystal molecules are coated on a TFT substrate, a color filter covers the TFT substrate to, combine into an LCD panel, the LCD panel is cut into independent LCD screens; 3, a backlight, a polarizer and a peripheral circuit are installed for the LCD screen, to form a complete TFT-LCD module.

In the array substrate process, after forming the pixel array circuits of the array substrate on the glass substrate by depositing, the measurement of electrical parameters of the array substrate is performed on a detecting device. The array substrate detecting device is an electro-optical detecting device, which is a detecting device used for simulating a cell formed by the cell forming process. There are false electrical defect phenomena in the detecting process of the existing devices, which seriously affect detection of normal defects. A fundamental reason for false electrical defect phenomena is, that the electrical difference between adjacent pixels on the TFT is small, so as to make the difference between reflected light received by a Charge-Coupled Device (CCD) is small. Therefore, it causes difficulties in setting a detecting standard, and the false defect is formed, thereby a defect detection rate for an array substrate is affected. The detection rate is the basis of all defect analysis. Once the defect cannot be detected, the direction for improving is lost, thereby the quality improvement is seriously affected.

In an optical system of an existing array substrate detecting device, the reflected light received by the CCD is influenced by the cross-interference between normal and abnormal pixels, resulting in that the difference received by the CCD is small, thereby normal and abnormal pixels cannot be distinguished when setting the detecting standard, causing the false defect.

### SUMMARY

The technical problem to be solved in the present disclosure is how to improve the array substrate detection accuracy, the defect detection rate, and the product quality.

To solve the above technical problem, the present disclosure provides an optical system for an array substrate detecting device, including:

a light source;

a first polarizer, configured to receive light emitted by the light source and convert the light into first linearly polarized light;

an optical prism group, configured to receive the first linearly polarized light emitted by the first polarizer, and reflect the first linearly polarized light to a liquid crystal detecting head;

the liquid crystal detecting head, configured to convert the incident first linearly polarized light into second linearly polarized light by using an optical rotation characteristic of liquid crystal molecules, and emit the second linearly polarized light;

a second polarizer, configured to receive the second linearly polarized light reflected by the liquid crystal detecting head and transmitted by the optical prism group, and convert the second linearly polarized light into third linearly polarized light;

a light intensity detector, configured to receive the third linearly polarized light and calculate a light intensity of the third linearly polarized light;

wherein, the polarization directions of the first polarizer and the second polarizer are opposite.

Alternatively, the optical rotation characteristic of liquid crystal molecules is:

when the first linearly polarized light irradiates into the liquid crystal molecules in a direction parallel to an X-axis of the liquid crystal molecules, the polarization direction of the first linearly polarized light is changed;

when the first linearly polarized light irradiates into the liquid crystal molecules in a direction parallel to a Y-axis of the liquid crystal molecules, the polarization direction of the first linearly polarized light is unchanged. Alternatively, the optical prism group includes a polarizing beam-splitting prism.

Alternatively, the beam-splitting prism is a cube which is formed by adhering hypotenuse surfaces of two isosceles right triangle prisms.

Alternatively, a beam-splitting film is coated on the hypotenuse surfaces, the incident light irradiates into the beam-splitting prism and is divided into two beams on the adhered surfaces, one beam is reflected, and the other beam is transmitted.

Alternatively, the optical characteristic of the beam-splitting film is chosen to change the ratio of a reflection coefficient and a transmission coefficient, so as to make the two beams of light be the same or different.

Alternatively, the first polarizer transmits a light vector which vibrates perpendicularly to a light incident plane, and blocks a light vector which vibrates parallel to the light incident plane; the second polarizer blocks the light vector which vibrates perpendicularly to the light incident plane, and transmits the light vector which vibrates parallel to the light incident plane.

Alternatively, the first polarizer blocks a light vector which vibrates perpendicularly to a light incident plane, and transmits a light vector which vibrates parallel to the light incident plane; the second polarizer transmits the light vector which vibrates perpendicularly to the light incident plane, and blocks the light vector which vibrates parallel to the light incident plane.

Alternatively, the liquid crystal detecting head includes a transparent electrode and a reflecting mirror which are disposed oppositely, there is a liquid crystal layer between the transparent electrode and the reflecting mirror, a reflecting surface of the reflecting mirror is in contact with the liquid crystal layer.

Alternatively, the reflecting mirror is disposed close to the array substrate to be detected.

Alternatively, a DC voltage is applied to the transparent electrode and a pixel electrode on the array substrate to be detected respectively, so as to form an electric field between the transparent electrode and the pixel electrode and to implement polarization rotation of the liquid crystal molecules in the liquid crystal layer.

Alternatively, the light intensity detector is a charge-coupled device.

The present disclosure also provides an array substrate detecting device, including:

a base platform, configured to dispose an array substrate to be detected,

the optical system according to any of the above;

a data processing module, configured to analyze and compare light intensity values obtained by the light intensity detector in the optical system, to distinguish between normal and abnormal pixels on the array substrate to be detected.

### BRIEF DESCRIPTION OF THE DRAWINGS

FIG. 1 is a schematic view showing a structure of an optical system used for an array substrate detecting device according to an embodiment of the present disclosure.

FIG. 2 and FIG. 3 are schematic views showing optical rotation characteristics of liquid crystal molecules.

FIG. 4 and FIG. 5 are schematic views showing a principle of the structure of a liquid crystal detecting head when the voltage is applied and is not applied.

FIG. 6A and FIG. 6B are views showing test results for an array substrate detecting device in an existing technology, wherein FIG. 6A shows a test result for normal pixels while FIG. 6B shows a test result for abnormal pixels.

FIG. 7A and FIG. 7B are views showing test results for an array substrate detecting device according to an embodiment of the present disclosure, wherein FIG. 7A shows a test result for normal pixels while FIG. 7B shows a test result for abnormal pixels.

### DETAILED DESCRIPTION

The specific embodiments of the present disclosure will be described below in detail, with the accompanying drawings and the examples. The following embodiments are intended to illustrate the present disclosure, but not to limit the scope of the disclosure.

In the description of the disclosure, it should be noted that, the orientation or positional relationship indicated by the terms “up”, “down”, “left”, “right” or the like, is based on the orientation or positional relationship as shown in the drawings, which is only to simplify the description of the present disclosure, rather than indicate or imply that the devices or elements need to have a particular orientation, or to be composed of or operated in a particular orientation, and therefore cannot be construed as limiting the present disclosure.

In the description of the present disclosure, it should be noted that, unless otherwise expressly specified and defined, the terms “mount”, “connect”, and “couple” should be understood broadly. For example, they may be to connect fixed, or to connect detachably, or to connect integrally; they may be to connect mechanically, or to connect electrically; they may be to connect directly, or to connect indirectly through an intermediary, or to connect inside two elements. The specific meaning of the above terms in the present disclosure can be understood by those ordinary skilled in the art according to actual conditions.

In the description of the present disclosure, the “first”, “second”, “third” are only used for the convenience of description, but not for implying the relative importance.

In order to improve the detection accuracy of normal and abnormal pixels during an array substrate detecting process, and to improve the defect detection rate to avoid a product with a defect to be used as a product without a defect, and to improve the product quality, the present disclosure provides an optical system for an array substrate detecting device. In such optical system, with the help of a polarizer through which only one direction of a vector light wave can pass, a direction vector of a light wave of a reflected light is affected by the liquid crystal optical rotation effect, and then the light wave is filtered by a polarizer, so that the difference between intensities of the reflected light of normal and abnormal pixels received by a light intensity detector is increased, so as to make it easy to set the detecting standard and distinguish normal and abnormal pixels, so as to reduce the false defect generation, improve the detection rate, and provide directions for improving the product quality.

Specifically, as shown in FIG. 1, the optical system used for the array substrate detecting device according to the present embodiment includes a light source 1, a first polarizer 2, an optical prism group 3, a liquid crystal detecting head 4, a second polarizer 6 and a light intensity detector 5, wherein the light intensity detector alternatively is CCD 5.

The light source 1 emits natural light. The first polarizer 2 receives the light emitted by the light source 1 and converts it into first linearly polarized light, as shown by the arrow from the first polarizer 2 in FIG. 1. The first polarizer 2 filters light in a certain vibration direction out of the natural light, and retains light in a vibration direction perpendicular to the aforementioned vibration direction. The optical prism group 3 receives the first linearly polarized light emitted from the first polarizer 2, and reflects the first linearly polarized light to the liquid crystal detecting head 4. The liquid crystal detecting head 4 converts the first linearly polarized light entering into the liquid crystal detecting head 4 into second linearly polarized light and emits the second linearly polarized light by using the optical rotation characteristic of liquid crystal molecules (that is, the liquid crystal molecules may rotate the polarization direction of the light by 90° or 270°; when a voltage is applied to the liquid crystal molecules, the liquid crystal molecules does not change the polarization direction of the light due to the electric field effect; the whole liquid crystal molecules can function as an optical switch only when two polarizers are added, wherein one polarizer is a polarization initiator (close to the light source) while the other one is a polarization analyzer (close to eyes)), as shown by the reflected light irradiating into the optical prism group 3 in FIG. 1. The second linearly polarized light has a polarization direction different from that of the first linearly polarized light, so that after irradiating into the optical prism group 3, the second linearly polarized light can pass though and further irradiate into the second polarizer 6. The second polarizer 6 receives the second linearly polarized light, and further converts the second linearly polarized light into third linearly polarized light, that is, the second polarizer 6 also filter some of the light, the remaining part of the light irradiates into the CCD 5. The CCD 5 receives the third linearly polarized light and calculates the light intensity of the third linearly polarized light. In the above description, the polarization directions of the first polarizer 2 and the second polarizer 6 are opposite.

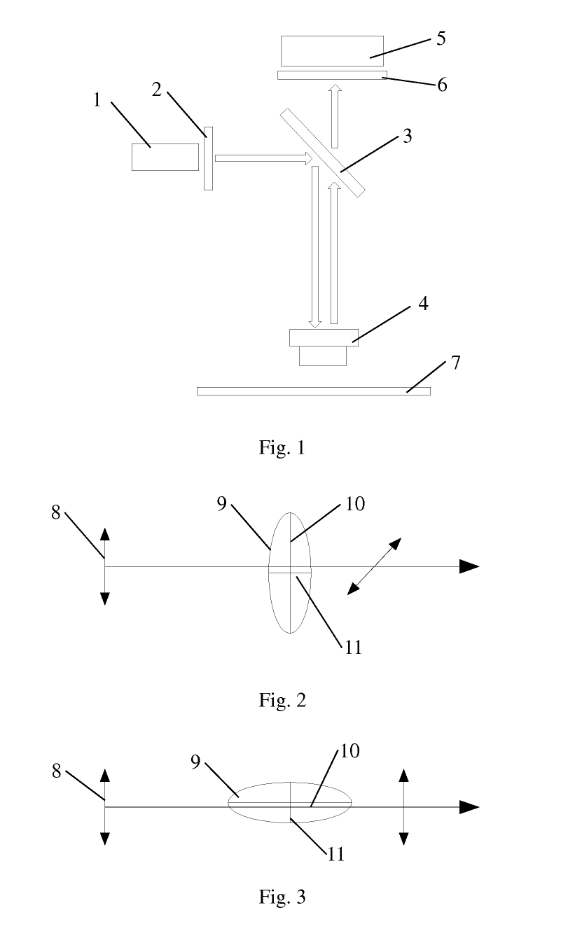

In the above optical system, the optical rotation characteristic of the liquid crystal molecules is shown in FIG. 2 and FIG. 3. Firstly, referring to FIG. 2, when the linearly polarized light 8 irradiates into the liquid crystal molecules 9 in a direction parallel to an X-axis 11 of the liquid crystal molecules, the polarization direction of the linearly polarized light 8 is changed; meanwhile, referring to FIG. 3, when the linearly polarized light 8 irradiates into the liquid crystal molecules 9 in a direction parallel to a Y-axis 10 of the liquid crystal molecules, the polarization direction of the linearly polarized light 8 remains unchanged.

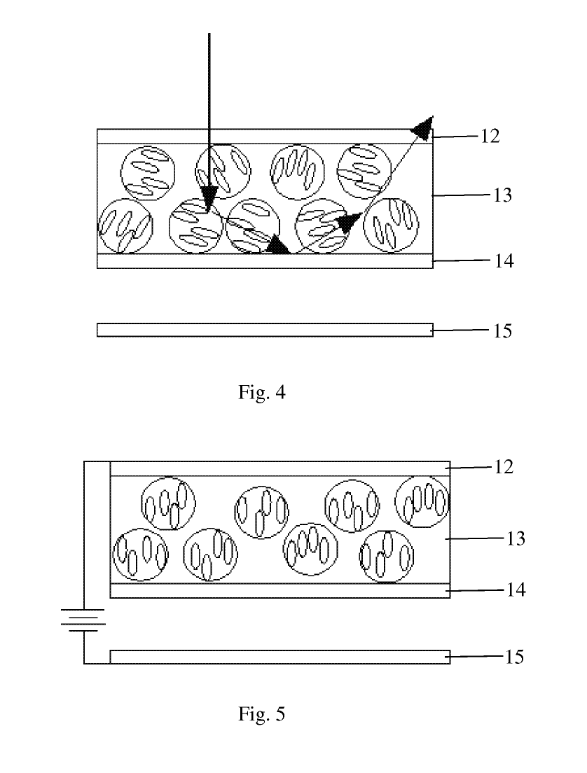

Referring to FIG. 4, the liquid crystal detecting head 4 of the present embodiment includes a transparent electrode 12 and a reflecting mirror 14 which are disposed oppositely. There is a liquid crystal layer 13 between the transparent electrode 12 and the reflecting mirror 14. A reflecting surface of the reflecting minor 14 is in contact with the liquid crystal layer 13. When the optical system of the present embodiment is used in the array substrate detecting device, the reflecting mirror 14 is disposed close to the array substrate to be detected. The position of a pixel electrode 15 as shown in FIG. 4 represents the position where the array substrate is disposed. After the optical system and the array substrate are arranged appropriately, the transparent electrode 12 and the pixel electrode 15 are applied with a certain voltage by using a DC power supply, so as to form an electric field between the transparent electrode 12 and the pixel electrode 15, and to implement the polarization rotation of the liquid crystal molecules 13 under effect of the electric field.

The detection principle of the detecting device is as follows. When no DC voltage is applied on the pixel electrode 15 and the transparent electrode 12, there exists no electric field between the transparent electrode 12 and the pixel electrode 15, so that the liquid crystal molecules in the liquid crystal layer 13 are not driven for polarization rotation and are disposed according to the original direction. The light (as indicated by the arrow in FIG. 4) is reflected by the reflecting mirror 14, then the direction of the light is changed when passing through the liquid crystal layer 13, thereby the light intensity received by the CCD 5 on the top is zero. As shown in FIG. 5, when a DC voltage is applied on the pixel electrode 15 and the transparent electrode 12 and a certain voltage difference is formed, an electric field is formed between the pixel electrode 15 on the array substrate and the transparent electrode 12 on the liquid crystal detecting head 4, the liquid crystal molecules generates polarization movement according to the direction of the voltage and the optical axis direction of the liquid crystal molecules is changed. In an ideal state, the reflected light, reflected by the reflecting mirror 14, is vertically reflected to the CCD 5 on the top. The light intensity received by the CCD 5 is E (E is the intensity of the incident light). When one of adjacent pixels appears abnormal, the normal pixel can be fully charged to make the liquid crystal molecules generate the polarization movement, while the abnormal pixel cannot be fully charged to make the liquid crystal to generate an uncompleted polarization movement, so that the reflected light intensity is E_{X}+E_{Y}+. . . (E_{X}, E_{Y} . . . represent components of the light intensity of different directions on the direction facing the CCD). In this way, the difference between the light intensities of the normal pixels and abnormal pixels received by the CCDs is small.

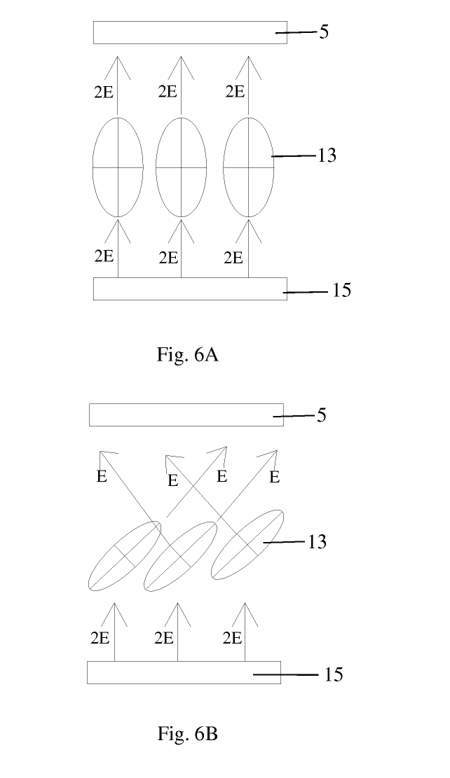

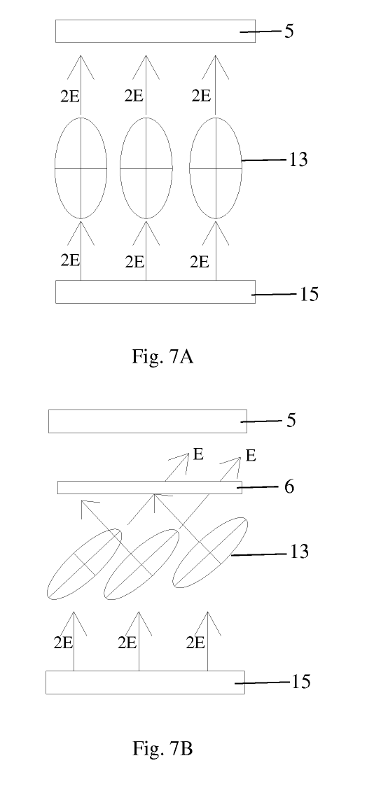

For example, as shown in FIGS. 6A and 6B, assuming that each pixel electrode 15 corresponds to three beams of light, the energy of each beam of light is 2E, the light intensity which is received by the CCD 5 and corresponds to the normal pixels (FIG. 6A) is 6E, while the light intensity which is received by the CCD 5 and corresponds to the abnormal pixels (FIG. 6B) is 4E, so the difference is 2E. Based on the optical system of the present embodiment, the DC voltage is applied on the array substrate. The light source 1 emits light, the light passes though the first polarizer 2 so as to form the first linearly polarized light. The first linearly polarized light is reflected by the optical prism group 3, and then irradiates into the liquid crystal detecting head 4. The first linearly polarized light is converted into the second linearly polarized light by using the optical rotation characteristic of the liquid crystal. The polarization direction of the first linearly polarized light and the polarization direction of the second linearly polarized light are opposite. Further, after passing though the second polarizer 6, the second linearly polarized light is received by CCD 5. The basic principle of the detection remains the same. The test results are shown in FIGS. 7A and 7B. Assuming that each pixel electrode corresponds to three beams of light, the energy of each beam of light is 2E, the light intensity which is received by the CCD and corresponds to the normal pixels (FIG. 7A) is 6E, while the light intensity which is received by the CCD and corresponds to the abnormal pixels (FIG. 7B) is 2E, so the difference is 4E.

From the above it can be known that, based on the optical system in the present embodiment, the difference between the reflected light intensities of normal and abnormal pixels on the array substrate can be increased. By simply setting the detecting standard, it can be distinguished that whether there exists an abnormal pixel on the array substrate, so as to detect defective products.

In the present embodiment, the optical prism group 3 includes a polarizing beam-splitting prism. The beam-splitting prism is a cube which is formed by adhering hypotenuse surfaces of two isosceles right triangle prisms. A beam-splitting film is coated on the hypotenuse surface. The incident light irradiates into the beam-splitting prism and is divided into two beams on the adhered surfaces, one beam is reflected, and the other beam is transmitted. The optical characteristic of the beam-splitting film may be chosen depending on needs. The ratio of the reflection and transmission coefficients can be changed to make the two beams of light be the same or different. When the beam-splitting film has a plurality of layers glued by materials with different refractive indexes, it is able to make the incident natural light, after passing though the adhered layer, generate emergent light in different polarization states, to achieve the separation and combination of light.

The polarization directions of the first polarizer 2 and the second polarizer 6 described above are opposite, so that the difference between the light intensities of normal and abnormal pixels can be increased. The combination of the first polarizer 2 and the second polarizer 6 can be configured as: the first polarizer 2 transmits the light vector which vibrates perpendicularly to the light incident plane, and blocks the light vector which vibrates parallel to the light incident plane; the second polarizer 6 blocks the light vector which vibrates perpendicularly to the light incident plane, and transmits the light vector which vibrates parallel to the light incident plane; or, the first polarizer 2 blocks the light vector which vibrates perpendicularly to the light incident plane, and transmits the light vector which vibrates parallel to the incident plane; the second polarizer 6 transmits the light vector which vibrates perpendicularly to the light incident plane, and blocks the light vector which vibrates parallel to the light incident plane.

Taking the first combination as an example, the working principle of the embodiment will be further described in conjunction with the optical system as shown in FIG. 1. The light source 1 emits nature light, the nature light passes though the first polarizer 2, the light vector which vibrates parallel to the light incident plane is blocked, while the light vector which vibrates perpendicularly to the light incident plane is transmitted, and the light irradiates into the optical prism group 3. In this case, the optical prism group 3 reflects the light, and the light vector which vibrates perpendicularly to the light incident plane is reflected to the liquid crystal detecting head 4. By the effect of the liquid crystal molecules, the polarization direction of the light vector which vibrates perpendicularly to the light incident plane is changed, and the light vector is reflected by the liquid crystal detecting head 4. The reflected light vector passes through the optical prism group, and then passes through the second polarizer 6. When the pixel electrode on the array substrate is normal, the liquid crystal molecules are all in the same polarization direction, so the light vector reflected by the liquid crystal detecting head 4 is the light vector which vibrates parallel to the light incident plane, and the light vector directly passes through the second polarizer 6, then is received by the CCD 5.

When the pixel electrode on the array substrate is abnormal, the liquid crystal molecules are not in the same polarization direction, so the light vector reflected by the liquid crystal detecting head 4 includes the light vector which vibrates parallel to the light incident plane and the light vector which vibrates perpendicularly to the light incident plane. The light vector which vibrates perpendicularly to the incident plane is filtered by the second polarizer 6, while the light vector which vibrates parallel to the incident plane directly passes though, so that the light intensity received by the CCD 5 is greatly reduced, the difference between the light intensity values reflected by the normal pixel and the abnormal pixel is increased.

Based on the above optical system, the present disclosure also provides an array substrate detecting device, including the above optical system, configured to increase the difference between the reflected light intensities of normal and abnormal pixels on an array substrate to be detected, a base platform, configured to dispose the array substrate to be detected, and a data processing module, configured to analyze and compare light intensity values obtained by CCDs, to distinguish between normal and abnormal pixels on the array substrate to be detected.

By using such detecting device to detect the array substrate, it is able to make it easy to set the detecting standard and distinguish between normal and abnormal pixels, so as to reduce the false defect generation, improve the detection rate, and provide directions for improving the product quality.

The above are only preferred embodiments of the present disclosure. It should be noted that for those of ordinary skill in the art, modifications and substitutions may be made without departing from the principles of the present disclosure, and should also be considered as falling within the scope of the present disclosure.

What is claimed is:

1. An optical system, comprising:
a light source;
a first polarizer, configured to receive light emitted by the light source and convert the light into first linearly polarized light;
an optical prism group, configured to receive the first linearly polarized light emitted by the first polarizer, and reflect the first linearly polarized light to a liquid crystal detecting head;
the liquid crystal detecting head, configured to convert the incident first linearly polarized light into second linearly polarized light by using an optical rotation characteristic of liquid crystal molecules, and emit the second linearly polarized light;
a second polarizer, configured to receive the second linearly polarized light reflected by the liquid crystal detecting head and transmitted by the optical prism group, and convert the second linearly polarized light into third linearly polarized light;
a light intensity detector, configured to receive the third linearly polarized light and calculate a light intensity of the third linearly polarized light;
wherein, the polarization directions of the first polarizer and the second polarizer are opposite.

2. The optical system according to claim 1, wherein, the optical rotation characteristic of liquid crystal molecules is:
when the first linearly polarized light irradiates into the liquid crystal molecules in a direction parallel to an X-axis of the liquid crystal molecules, the polarization direction of the first linearly polarized light is changed;
when the first linearly polarized light irradiates into the liquid crystal molecules in a direction parallel to a Y-axis of the liquid crystal molecules, the polarization direction of the first linearly polarized light is unchanged.

3. The optical system according to claim 1, wherein, the optical prism group comprises a polarizing beam-splitting prism.

4. The optical system according to claim 3, wherein, the beam-splitting prism is a cube which is formed by adhering hypotenuse surfaces of two isosceles right triangle prisms.

5. The optical system according to claim 4, wherein, a beam-splitting film is coated on the hypotenuse surfaces, the incident light irradiates into the beam-splitting prism and is divided into two beams on the adhered surfaces, one beam is reflected, and the other beam is transmitted.

6. The optical system according to claim 5, wherein, an optical characteristic of the beam-splitting film is chosen to change the ratio of a reflection coefficient and a transmission coefficient, so as to make the two beams of light be the same or different.

7. The optical system according to claim 1, the first polarizer transmits a light vector which vibrates perpendicularly to a light incident plane, and blocks a light vector which vibrates parallel to the light incident plane; the second polarizer blocks the light vector which vibrates perpendicularly to the light incident plane, and transmits the light vector which vibrates parallel to the light incident plane.

8. The optical system according to claim 1, wherein, the first polarizer blocks a light vector which vibrates perpendicularly to a light incident plane, and transmits a light vector which vibrates parallel to the light incident plane; the second polarizer transmits the light vector which vibrates perpendicularly to the light incident plane, and blocks the light vector which vibrates parallel to the light incident plane.

9. The optical system according to claim 1, wherein, the liquid crystal detecting head comprises a transparent electrode and a reflecting minor which are disposed oppositely, there is a liquid crystal layer between the transparent electrode and the reflecting mirror, a reflecting surface of the reflecting mirror is in contact with the liquid crystal layer.

10. The optical system according to claim 9, wherein, the reflecting minor is disposed close to the array substrate to be detected.

11. The optical system according to claim 10, wherein, a DC voltage is applied to the transparent electrode and a pixel electrode on the array substrate to be detected respectively, so as to form an electric field between the transparent electrode and the pixel electrode and to implement polarization rotation of the liquid crystal molecules in the liquid crystal layer.

12. The optical system according to claim 1, wherein, the light intensity detector is a charge-coupled device.

13. An array substrate detecting device, comprising:
a base platform, configured to dispose an array substrate to be detected,
the optical system according to claim 1;
a data processing module, configured to analyze and compare light intensity values obtained by the light intensity detector in the optical system, to distinguish between normal and abnormal pixels on the array substrate to be detected.

14. The array substrate detecting device according to claim 13, wherein, the optical prism group comprises a polarizing beam-splitting prism.

15. The array substrate detecting device according to claim 13, wherein, the first polarizer transmits a light vector which vibrates perpendicularly to an light incident plane, and blocks a light vector which vibrates parallel to the incident plane; the second polarizer blocks the light vector which vibrates perpendicularly to the light incident plane, and transmits the light vector which vibrates parallel to the light incident plane.

16. The array substrate detecting device according to claim 13, wherein, the first polarizer blocks a light vector which vibrates perpendicularly to an light incident plane, and transmits a light vector which vibrates parallel to the light incident plane;
the second polarizer transmits the light vector which vibrates perpendicularly to the light incident plane, and blocks the light vector which vibrates parallel to the light incident plane.

17. The array substrate detecting device according to claim 13, wherein, the liquid crystal detecting head comprises a transparent electrode and a reflecting mirror which are disposed oppositely, there is a liquid crystal layer between the transparent electrode and the reflecting minor, a reflecting surface of the reflecting minor is in contact with the liquid crystal layer.

18. The array substrate detecting device according to claim 17, wherein, the reflecting mirror is disposed close to the array substrate to be detected.

19. The array substrate detecting device according to claim 18, wherein, a DC voltage is applied to the transparent electrode and a pixel electrode on the array substrate to be detected respectively, so as to form an electric field between the transparent electrode and the pixel electrode and to implement polarization rotation of the liquid crystal molecules in the liquid crystal layer.

20. The array substrate detecting device according to claim 13, wherein, the light intensity detector is a charge-coupled device.
